(19) United States
(12) Patent Application Publication
(10) Pub. No.: US 2015/0382403 A1
(43) Pub. Date: Dec. 31, 2015

(54) HEATING ELEMENT

(71) Applicant: SWANSEA UNIVERSITY, Swansea (GB)

(72) Inventors: Bruce Philip, Singleton Park (GB); Eifion Jewel, Singleton Park (GB)

(21) Appl. No.: 14/765,541

(22) PCT Filed: Feb. 5, 2014
(86) PCT No.: PCT/GB2014/000045

§ 371 Date: Aug. 3, 2015

(30) Foreign Application Priority Data
Feb. 5, 2013 (GB) 1302072.2
Jul. 23, 2013 (GB) 1313084.4

(51) Int. Cl. H05B 3/00; H05B 3/02; H05B 3/12; H05B 3/14; H01H 9/10; H05B 3/18; F24D 13/02; E04D 13/064; E04B 5/48; G05D 23/20; H05B 3/06; H05B 3/16

(52) U.S. Cl. CPC H05B 3/0014; H05B 3/06; H05B 3/026; H05B 3/12; H05B 3/146; H05B 3/145; H05B 3/16; H05B 3/18; F24D 13/024; E04D 13/064; E04B 5/48; G05D 23/20; H01H 9/10

(57) ABSTRACT

The present invention provides a heating element (L) formed as a laminate including a thermally conductive substrate (1) having a first surface coated at least in part with an electrically insulating coating layer (2). The electrically insulating layer is backed with an electrically resistive layer (3), formed of a non-conducting matrix material that is loaded with conductive material to allow current to be passed through the resistive material to generate heat which can be conducted out through the thermally conductive substrate (1). An electrically and thermally insulating layer (6) backs layer (3) and direct heat through the second surface and to provide support and encapsulation to the resistive element of the system.

### FIELD OF THE INVENTION

The present invention relates to a heating element and in particular but not exclusively to a heating element formed by an electrically resistive coating applied to a thermally conducting substrate. In addition the invention relates to a heating system such as a raised access flooring system which incorporates such a heating element.

### BACKGROUND OF THE INVENTION

It is known to have radiant panel heaters incorporating a heating element in the form of a film of electrically resistive material that has been deposited on an insulating substrate and such panels are discussed in GB 2 244194 and in this case, the electrically resistive film is in turn covered by a further insulating layer. The major part of the heat, which such radiators generate, is produced by heating air which is then circulated, producing a convection current circulating the heated air. Because of the thickness of the insulating layers, they cannot be described as true radiant heaters where the major part of the heat generated is produced by radiation. It is a disadvantage of the known radiant panel heaters that they are not true radiant heaters.

WO 2005/0022954 discusses a radiator panel having a conducting paint which is sandwiched between a silicon impregnated mica substrate and a mica insulating layer to produce a radiant heat panel. However there is no ability to direct the heat and reduce thermal losses.

An additional disadvantage of known panel heaters is that they are bulky items which may not be suitable in some locations or may impose unacceptable constraints on interior design or internal arrangements. Further, known panel heaters are expensive to produce and they have to be fitted as a separate element in a space rather than being able to use existing elements or elements that can be easily conformed to fit in the space available.

Raised access suffice systems may be attached directly to an existing building element such as a solid floor, wall, roof or ceiling, or attached via a flume to provide a void between the raised access member and the building element. One such system is raised access flooring, which provides an elevated structural floor above a solid subfloor to create a hidden void for the passage of mechanical and electrical services. This type of flooring is installed in the majority of modern office buildings and in specialised areas such as control centres, IT data centres and computer rooms where there is a requirement to route mechanical services, cables and electrical supply. This type of flooring can be installed in a variety of heights, ranging from 50 mm to approximately 1500 mm. The most common floor tile dimension is 600×600 mm, though other sizes are available. Tile thicknesses are typically 30 mm for most standard office applications and 40 mm for some heavier duty applications although again other thicknesses are available.

Known floors typically consist of rectangular panes supported on each corner by pedestals. The height depends on the volume of cables and other services provided beneath but typically there is a clearance of at least 150 mm. The panels are normally made of steel clad particleboard or a steel panel with a cementitious internal core, although some tiles may have hollow cores. However these known systems are simply structural elements of a building and do not form part of the services to the building such as the provision of heating.

The present invention seeks to overcome the problems of the prior art by providing a heating element that is highly thermally conductive, which can be fitted in a range of situations and if needs be, can use exiting infrastructures for installations and which can efficiently direct heat and limit thermal losses. Further, for raised access surface systems the invention provides an easy to install system which not only has a neat appearance but which also is an easy to install system that can protect wiring and piping that connect services to a building.

### SUMMARY OF THE INVENTION

According to a first aspect of the invention there is provided a heating element formed as a laminate including a thermally conductive substrate having a first surface and a second surface, said second surface being coated at least in part with an electrically insulating layer, characterised in that said electrically insulating layer is covered at least in part with an electrically resistive layer which is in electrical contact with connectors to enable said heating element to be connected to a power supply so a current can be passed through the electrically resistive layer, a surface of said electrically resistive layer opposite to that which is in contact with the electrically insulating layer being in contact with an electrically and thermally insulating layer such that when a current is passed though the electrically resistive layer to generate heat, heat is directed by said electrically and thermally insulating layer to be radiated out through the first surface of the thermally conductive substrate.

Preferably the electrically resistive layer is formed of a non-conducting material that is loaded with conductive material. The conductive material allows current to be passed through the electrically resistive material to generate heat which can be conducted out through the thermally conductive substrate.

Preferably the electrically and thermally insulating layer provides support for the electrically resistive layer and can also encapsulate said electrically resistive layer and also the busbars and contacts. The fact that the busbars and contacts are encapsulated assists in making the system robust and more resistant to damage to electrical contacts.

It is preferred that the thermally conductive substrate is a metal.

It is envisaged that the metal is steel, stainless steel, titanium, aluminium or copper or an alloy or a laminate formed of layers of different thermally conductive metals.

It is preferred that the electrically resistive layer is an organic material loaded with a conductive material.

It is envisaged that the electrically resistive layer may be a positive temperature coefficient material providing self-regulation of temperature.

Preferably the organic material is an organic matrix material selected from one or more of an acrylic, acetate, silicone, polyester, polyurethane, PVC (polyvinylchloride), polyimide or other long chain polymeric molecule

Preferably the conductive material is a pigment material selected from carbon black and/or carbon graphite.

It is preferred that the carbon black and/or carbon graphite is distributed within the organic material in selected one or more orientations to enable directional current flow or the carbon black and for graphite may be combined with carbon nanotubes, nanowires or graphene that may be orientated in a particular direction to allow the most appropriate current flow.

It is envisaged that the electrically resistive layer is in the form of a paint. The paint may be applied to the thermally conductive substrate on the opposite side to that which faces the outer layer of the laminate and then electrically resistive coating is applied.

It is preferred that the electrically resistive layer may be in a lamellar form or is in an array on a sheet of electrically conductive material.

Preferably the electrically resistive layer is connected to electrodes or busbars that feed power to the resistive coating.

It is envisaged that the electrodes or busbars are positioned at either end of the electrically resistive coating. As an alternative the electrodes or busbars may be formed on a sheet of electrically resistive coating that is then positioned in the laminate. Using this architecture porous non-conducting layer may be incorporated into the electrically resistive layer to provide a fixed separation and to prevent short circuiting between the electrodes or busbars.

Preferably the electrodes are printed material on the electrically resistive coating or alternatively the electrically resistive material may be printed over the electrodes. However as an alternative the electrodes may be metal, braided metal or laminated metal entities. The electrodes are preferably in the form of a conductive ink applied to the substrate. The electrical connections convey electrical current from a power distribution network to the electrodes and in the case of a raised access member such as a floor tile, the resistive layer is built into the raised access floor tile, to allow ease of electrical connection to a power distribution network in the void below the raised access floor.

The heating system according to the invention includes a power supply, which power supply may be a mains voltage supply, energy storage device, or means for supplying any other voltage, for example a voltage of less than 50 volt. The power supply may be AC current or DC current.

The electrically and thermally insulating layer is preferably polyurethane foam/glass wool/aerogel or chipboard/ply wood/MDF/plasterboard, cementitious or similar material or a moisture absorbent building material. Moisture absorbent materials include Hemcrete®, which may be used with a heating element to draw moisture out of a building.

It is envisaged that the thermally conductive substrate is formable to provide a contoured heating element.

The contoured heating element is a building element such as a roof panel, a gutter, drainpipe, floor panel, wall panel or ceiling tile.

It is envisaged that the heating element may be incorporated into a photovoltaic panel.

It is envisaged that the heating element may take the form of a portable heating device.

Preferably the heating element may be connected to a thermostat or use a room thermostat for regulating the supply of electricity to the element in response to a measured temperature.

It is preferred that the heating element is incorporated in a raised access member formed as a laminate including a thermally conductive substrate having first and second surfaces the first surface forming an outer face for the raised access member the second surface being in contact with, at least in part, the electrically insulating layer with the raised access member also having connectors to enable the raised access member to be attached to a power supply. The power supply may be in a void under the raised access member or it may be integrated into the laminate structure that forms the heating element.

Preferably the raised access member is a floor tile with the outer face being able to transmit heat from the floor tile to a space above the tile.

It is envisaged that the raised access member forms a wall panel, a floor panel or even guttering or outside drainage pipes or roof panels and in particular the surface can be used to remove frozen material from a surface such as snow or ice.

Preferably the heating element forms part of a raised access flooring system including one or more raised access members that include a heating element each of said raised access members also having connectors to enable the raised access member to be attached to a power supply, said system also having one or more pedestals to support respective one or more raised access members said pedestals each carrying connectors that can mate with the connectors on respective raised access members so that power can be supplied to the raised access member from power supplies running in a void provided by the one or more raised access members. However as an alternative in the ease of a raised access floor, stringers which are used to provide lateral stability between pedestals could also carry contact and electrical power to supply the heated, raised access floor tile.

The raised access member and or flooring system may be connected to a thermostat for regulating the supply of electricity to the element in response to a measured temperature. It may be that different raised access members are in communication with different thermostats so zoned heating of an area may be provided. Further it is envisaged that to further strengthen the system it may include stringers that provide support for the one or more raised access members positioned on the one or more pedestals.

### BRIEF DESCRIPTION OF THE DRAWINGS

Embodiments of the present invention are described in more detail below, by way of illustrative example only, in conjunction with the accompanying figures, of which:

FIG. 1 is a cross-sectional view of a heating element according to an embodiment of the invention.

FIG. 2 shows: a cross-sectional view of a raised access member according to an embodiment of the invention;

FIG. 3 shows: a cross sectional view of a further raised access member with differently positioned electrodes/busbars;

FIG. 4 shows: a raised floor system including raised access members; and

FIG. 5 shows details of a pedestal used with a raised access member according to an embodiment of the invention.

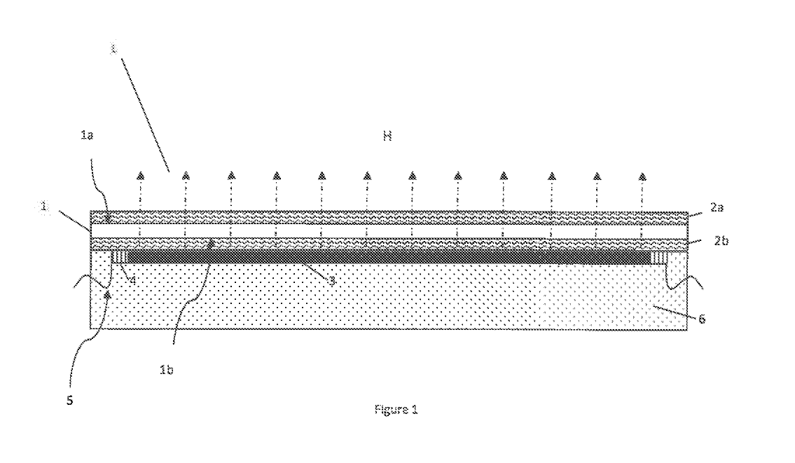

As shown in FIG. 1, the heating element is formed of a laminate structure generally shown as L in the figure. The laminate includes a thermally conductive substrate 1, which is generally a metal layer. The metal layer as shown, is a flat sheet material, however the sheet may be bent into any required shape to be used. Also the thermally conductive substrate may be an existing material in a building, for example a metal wall.

The thermally conductive substrate 1 is coated with a first electrically insulating layer 2a on a first surface 1a of the substrate. A second electrically insulating layer 2b is present on an inner surface 1b of the substrate. The second surface is towards the core of the heating element while the first surface is towards an outer layer of the heating element and from which heat radiates from the heating element L. The layers 2a,2b are substantially parallel to one another although it is envisaged that rather than a linear structure, the layers could be any other shape e.g. sinusoidal if the thermally conductive layer 1 is of that shape. An electrically resistive coating 3 is applied to the layer 2b and this electrically resistive coating may be in the form of a paint which may be applied or printed on the thermally conductive substrate 1. The coating may be of a thickness of 10 to 200 microns, more preferably 20 to 120 microns. The electrically resistive coating is preferably as polymer matrix that has a conductive pigment material incorporated in it although any material may be used that provides electrical resistance and which can be coated in as thin enough layer on the element. The resistive layer can be in the form of a continuous layer, or a pattern. The output from the system is dictated by the composition, thickness and area covered by the resistive material in combination with the electrical supply. This can allow for the production of heat at particular localities which may be of a particular benefit in building material, for example heat may be generated at cold spots in a building, while less heat is generated in wanner areas. This can result in localised heating where needed which means that there is less need to heat in other areas, which in turn can result in less energy consumption. The use of less energy will have profound environmental impact as less power is needed.

The electrically resistive layer 3 (which may as an alternative be provided as a coating) is connected to electrodes (or busbars) 4, which may be located at the ends of a sheets of electrically resistive layer 3 or alternatively the electrodes may be located at required positions on the electrically resistive layer to facilitate the required power distribution. The busbars may be a printed conductive ink, a metal foil, braid, or one of the busbars could use the electrically conductive properties of the metal substrate. The bus bars are in turn connected to electrical connectors 5, which feed power to the heating element.

There is a thermally and electrically insulating layer 6, which is connected to the face of the electrically resistive layer 3 that is opposite to that which is attached to the thermally conductive substrate 1. The thermally and electrically insulating layer provides both support and encapsulation to the electrically resistive layer 3 and the conductive busbars.

The layer 2a is an optional layer and if present it forms an external surface of the heating element and provides a protective surface for the heating element. It is envisaged that a decorative element may be attached to the layer 2a or it may even be the case that decorative material are incorporated in the second layer to form an integral electrically insulating layer and decorative surface.

The heating element can be adapted for mounting on a wall, floor, ceiling or similar surface or for mounting within a housing, for example a freestanding housing, or for external applications, for example roof panels, gutters, etc. or for incorporation into a photovoltaic panel, or a portable heating device, or to heat an enclosure, for example a domestic appliance. Other applications for the heating element include use in housing fixtures e.g. gutters, stairs, window frames, the automotive sector e.g. Car roofs, doors, heated mirrors, and other areas such as air ducts, trains, planes, clothes drying, garage shutter doors, farm sheds, shoe drying cabinets, outdoor furniture, benches/seats, yachts boats/ships, heated pools, spa-sauna/steam rooms, bus/train stops shelters, beds, poultry (incubators and hen coops), hot food plates/hostess trolleys, motor vehicles, towel racks, catalyst surfaces, portacabins, caravans, horse trailers or any other structure where heating is required or desired. A further application is the use of the heating element for controlling moisture levels/drying of cementitious or lime based floors/walls.

The heating element is preferably substantially rectangular in shape, with the electrodes extending along opposite sides of the substantially rectangular electrically resistive layer. The shape of the heating element may take other forms, for example circular, with electrodes distributed across the surface of the electrically resistive layer to provide heat distribution that is most advantageous for a given application. The invention uses the principle of electrical resistive heating to deliver an increase in temperature by passing an electrical current through a coating which is rendered partially conducting due to a high loading of conductive pigment. The coating can be deposited by a range of methods including, but not limited to, screen printing, roller coating, spray coating and slot dying, at a range of thicknesses. The coating resistance is controlled by composition, thickness and surface area. The electrical current is supplied to the printed conductive coating through electrical connections to low resistance electrodes or busbars, which may be printed or laminated to the substrate or take the form of as braid or wire. The heating element may be powered directly from a mains electrical supply or from an energy storage device and may be fixed or portable.

The coating can be applied to pre-painted metal, or metal-polymer-laminated substrates in either flat sheets or formed into shapes. The conducting coating forms a layer within a composite structure and is sandwiched between the thermally conductive layer 1 i.e. a metal layer and an electrically and thermally insulating layer 6. By applying the conducting coating and electrical contacts to the reverse side of coated metal, the conducting layer and all the electrical contacts are sealed in by the insulating layer. Heat generated by the coating is transmitted through the metal substrate by conduction while the insulating layer minimises the heat lost, thereby providing a mechanism for directing the heat to where it is required.

Finally, in building applications the metal substrate layer will be earth bonded to provide added protection. The electrical contacts will be incorporated into the thermally insulating layer to facilitate easy and rapid connection to the power supply. The design of electrical contacts will be tailored to the particular application, for example using push fittings or spring loaded contacts.

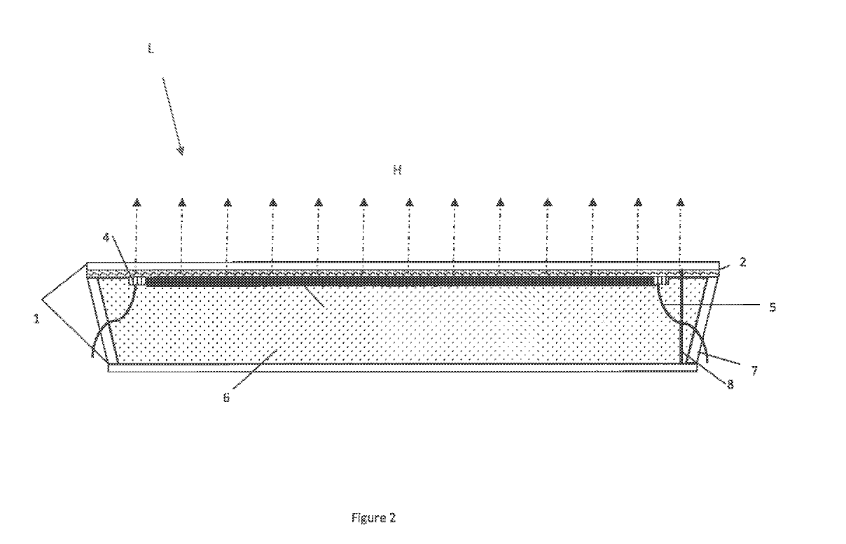

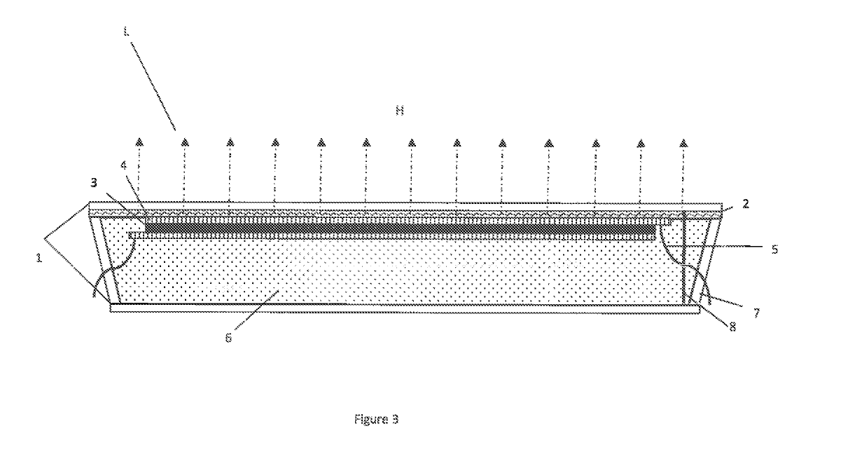

As shown in FIG. 2, the heating element is formed of a laminate structure which again is generally shown as L in the figure. The laminate includes a thermally conductive substrate material 1, which is generally a metal layer and is positioned to provide an outer surface of the laminate. The metal layer as shown, is a flat sheet material. The metal layer is usually the size of a floor the and may be covered with a layer of floor covering such as a carpet tile, wood laminate, etc. The carpet tile would provide the insulating material on the outer surface of the tile. Although a sheet is shown in the figure the sheet may be countered, for example if it were to provide a threshold strip.

The underside of the conductive substrate 1 (that does not form the outer surface of the laminate) is coated with an electrically insulating layer 2. The next layer towards the centre of the laminate is the electrically resistive layer/coating 3. The electrically resistive coating comprises a non-conducting material that is loaded with conducting material that allows the passage of current through the resistive material to generate heat which is then conducted through the thermally conductive material. The electrically resistive layer or coating can be applied to pre-painted metal substrates in either flat sheets or formed into shapes. By applying the conducting coating and electrical contacts to the reverse side of coated metal, the conducting layer and an the electrical contacts are sealed in by the insulating layer. Heat generated by the coating is transmitted through the metal substrate by conduction while the insulating layer minimises the heat lost, thereby providing a mechanism for directing the heat to where it is required.

Electrical busbars or electrodes 4, which may be printed, or take the form of a metal laminate, braid or tape, are in electrical contact with the resistive coating and as shown are positioned at discrete locations on the coating (the position shown being at the ends of a layer of the resistive coating) and carry power to the resistive coating. As an alternative the electrodes/busbars may run along opposite edges of the coating or form a network of conductors above or below the resistive layer. The layer and electrical busbars are sufficiently thin that they can be incorporated into the sandwich construction of the tile without significantly altering the overall thickness of the raised access floor tile or significant alteration to the manufacturing process. The busbars may also be a printed conductive ink, a metal foil, braid, or one of the busbars could use the electrically conductive properties of the metal substrate. The busbars are in turn connected to electrical connectors 5, which emerge on the lower surface of the composite panel to provide ease of connection to the power distribution network in the void below the raised access tile. The connectors may be routed around the edge of the supporting/thermally and electrically insulating core of the floor tile or simply go directly through the core material of the tile.

In this invention the resistive coating is applied to the under surface of the top metal sheet of a raised access floor panel comprising of a supporting, thermally insulating substrate 6 which may be made of wood, particle board, or a cementitious derived product, that is sandwiched between two layers of sheet metal, for example, but not limited to a steel substrate. The metal sheet may be pre painted with an electrically insulating layer 2 prior to application of the resistive layer/coating or an electrically insulating coating may be applied directly to the metal substrate prior to application of the resistive coating.

The electrical contacts that facilitate connection between the heating element within the raised access member and a distributed electrical power supply in the void are made through contacts that can be mounted on or in the floor pedestals or lateral support stringers. In either embodiment, the design of the electrical interconnects between the tile and pedestals are such that the method of floor installation is not significantly altered and the system allows complete flexibility to supply power to discrete tiles, strings of tiles or any desired pattern. The low voltage design is such that the supply fails within industry safety parameters for example the voltage is 50 Volts or less and does not present a hazard to health through the potential for electric shock. The edge of the floor tile is often coated with a non.-conductive edge banding 7 to provide protection to the core material and insulation of the whole tile. The edges of the raised access member are chamfered so that it is easier to lay down the members on a surface as there is some clearance when the edge of one member is laid against another. Earth contacts 8 can be used to maintain the upper and lower metal sheets at earth potential through direct connection to the earthed, metal pedestals.

FIG. 3 shows a similar arrangement to that of FIG. 2 except that the electrical busbars/electrodes 4 take the form of a metal laminate, mesh or tape positioned on either side of the electrically resistive coating. The resistive coating and electrical busbars are sufficiently thin that they can be incorporated into the sandwich construction of the tile without significantly altering the overall thickness of the raised access floor tile or significant alteration to the manufacturing process. Rather than having a complete layers as shown the electrodes/busbars can form a network or sheet of conductors above or below the resistive coating. A non-conductive, porous separator may be incorporated to the resistive layer to maintain a constant layer thickness and avoid short circuiting between electrodes. The resistive layer may take the form of a positive temperature coefficient (PTC) coating to provide self-regulation of heat output.

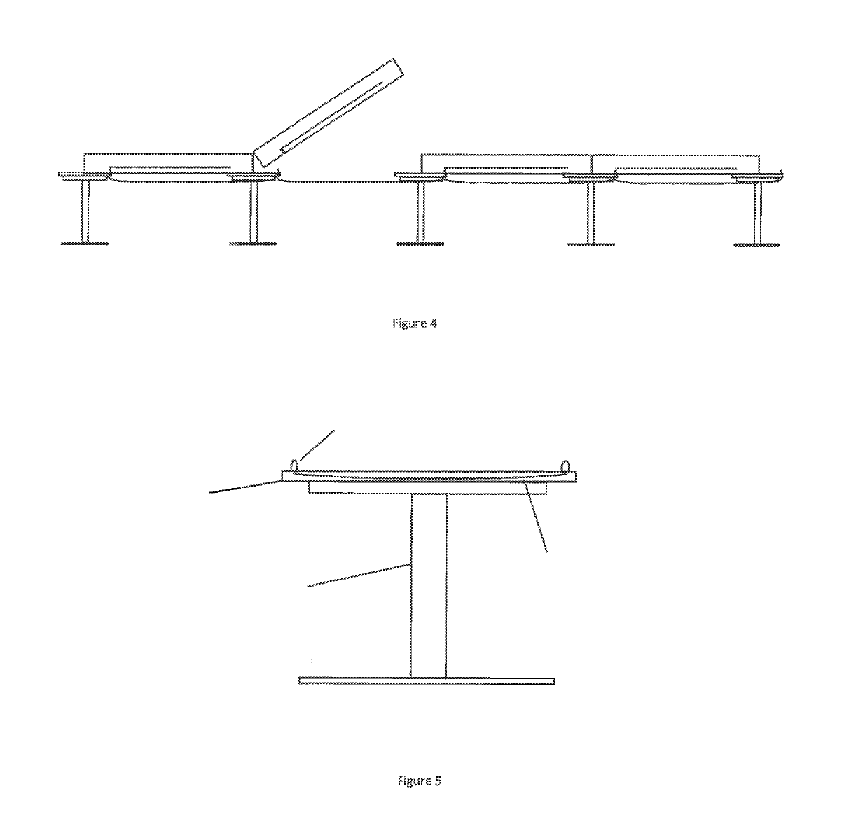

In FIG. 4, there is shown a series of raised access member supports each generally shown as 9. The heating element supports are formed of a pedestal upright 10 having a foot 11 which supports the pedestal upright. The pedestal upright has a load bearing element 12 that provides overall strength to the support and is particularly important when the raised access member support is for a raised access member 100 that is to form part of a flooring system. The lead bearing element is capped by a capping member 13 made of electrically insulating material such as a polymer which is in contact with a raised access member that is placed on it. There is an electrical connector 14 that runs between each of the supports or there may be substantially horizontal support e.g. stringers (not shown) however there are also isolators switches (not shown) so that power can be isolated from various supports and associated raised access members so that maintenance can be carried out for an area of the raised access members without harm to individuals. However in practice it is often the case that power is switched off remotely, either to zones of the panels or to the whole section of panels. If access is required for a void 16 beneath a raised access member the member can be simply lifted away from the support to access the void.

FIG. 5 shows in more detail, a raised access member support with the foot 11 supporting an upright or pedestal leg 101 on which there is a cap 13. The cap may also have a load bearing member 12 beneath it to strengthen the structure. The cap 13 may have contacts 15 located on an upper surface of the cap and there is a conductive connector 14 that may provide power to the contacts 15. The contacts 15 are sprung, upright pins or solid pins with resilience being provided by the polymeric cap onto which connectors on a raised access member can be located so that the contacts and the connectors in the raised access member are accurately aligned in order to provide power to heating element. Having a fixed locator indentation in the tile and matching protrusion in the support ensures correct orientation of the raised access floor tile ensuring correct orientation for connection to the power supply and facilitating simple and rapid installation. This means that the raised access member can be installed at the same time as the distributed power supply network, which means less cost and time and number of trades to lay down a raised access member such as a raised access floor or wall and separate heating system.

The heating element may be adapted for mounting on a wall, floor, ceiling or similar surface or for mounting within a housing, for example a freestanding housing, or for external applications, for example roof panels, gutters, etc. or for incorporation into a photovoltaic panel, or a portable heating device, or to heat an enclosure, for example a domestic appliance. The ability to heat the guttering in cold weather is advantageous as it can be used to melt snow or ice that has collected in the guttering as is the case for roofing elements or if a photovoltaic device is on a roof so that the device is kept clear of snow or ice.

Further the heating element is preferably substantially rectangular in shape, with the electrodes extending along opposite sides of the substantially rectangular electrically resistive layer. The Shape of the heating element may take other forms, for example circular, with electrodes distributed across the surface of the electrically resistive layer to provide heat distribution that is most advantageous for a given application. The invention uses the principle of electrical resistive heating to deliver an increase in temperature by passing an electrical current through a coating which is rendered partially conducting due to a high loading of conductive pigment. The coating can be deposited by a range of methods including, but not limited to, screen printing, roller coating, spray coating and slot dying, at a range of thicknesses. The coating resistance is controlled by composition, thickness and surface area. The electrical current is supplied to the printed conductive coating through electrical connections to low resistance electrodes or busbars, which may be printed or laminated to the substrate. The heating element may be powered directly from a mains electrical supply or from an energy storage device and may be fixed or portable. In particular the heating element is used in floor tiles that may be used in raised access flooring. The tiles may cover the whole of the flooring or just individual areas where people are sitting so they can take advantage of the local warming effect of the tile.

It is to be understood that the above embodiments have been provided only by way of exemplification of this invention and that further modifications and improvements thereto, as would be apparent to persons skilled in the relevant art, are deemed to fall within the broad scope and ambit of the present invention described. Furthermore where individual embodiments are discussed, the invention is intended to cover combinations of those embodiments as well.

1. A heating element formed as a laminate including a thermally conductive substrate having a first surface and a second surface, said second surface being coated at least in part with an electrically insulating layer, characterized in that said electrically insulating layer is covered at least in part with an electrically resistive layer which is in electrical contact with connectors to enable said heating element to be connected to a power supply so a current can be passed through the electrically resistive layer, a surface of said electrically resistive layer opposite to that which is in contact with the electrically insulating layer being in contact with an electrically and thermally insulating layer such that when a current is passed though the electrically resistive layer to generate heat, heat is directed by said electrically and thermally insulating layer to be radiated out through the first surface of the thermally conductive substrate.

2. A heating element according to claim 1 wherein the electrically resistive layer is formed of a non-conducting material that is loaded with conductive material.

3. A heating element according to claim 1 wherein the electrically and thermally insulating layer provides support for the electrically resistive layer and also encapsulates the electrically resistive layer.

4. A heating element according to claim 1, wherein the thermally conductive substrate is a metal.

5. A heating element according to claim 4, wherein the metal is steel, stainless steel, galvanised steel, titanium, aluminium or copper or an alloy or a laminate formed of layers of different thermally conductive metals.

6. A heating element according to claim 1 wherein the electrically resistive layer is an organic material loaded with a conductive material.

7. A heating element according to claim 6, wherein the organic material is an organic matrix material selected from one or more of an acrylic, acetate, silicone, polyester, polyurethane, PVC (polyvinylchloride), polyimide or other long chain polymeric molecule.

8. A heating element according to claim 7 wherein the conductive material is a pigment material selected from carbon black and/or carbon graphite.

9. A heating element according to claim 8 wherein the carbon black and/or carbon graphite is orientated in one or more directions to allow directional current flow.

10. A heating element according to claim 9, wherein the carbon black and/or graphite is combined with carbon nanotubes, nanowires or graphene.

11. A heating element according to claim 1 wherein the electrically resistive layer may be a positive temperature coefficient material providing self-regulation of temperature.

12. A heating element according to claim 1 wherein the electrically resistive layer is in the form of a paint.

13. A heating element according to claim 1 wherein the electrically resistive layer is connected to electrodes or busbars that feed power to the resistive coating.

14. A heating element according to claim 13, wherein the electrodes are printed material on the electrically resistive coating or alternatively the electrically resistive material may be printed over the electrodes.

15. A heating element according to claim 1 wherein the electrically and thermally insulating layer is polyurethane foam/glass wool/aerogel or chipboard/plywood/MDF/plasterboard, cementitious or similar material or absorbant building material.

16. A heating element according to claim 1 wherein the thermally conductive substrate is formable to provide a contoured heating element.

17. A heating element according to claim 16 wherein the contoured heating element is a building element such as a roof panel, a gutter, drainpipe, floor panel, wall panel or ceiling tile.

18. A heating element according to claim 1 16 wherein the heating element may be incorporated into a photovoltaic panel.

19. A heating element according to claim 1 wherein the heating element is incorporated in a portable heating device.

20. A raised access member incorporating a heating element according to claim 1 wherein the heating element is formed as a laminate including a thermally conductive substrate having first and second surfaces the first surface forming an outer face for the raised access member the second surface being in contact with, at least in part, the electrically insulating layer with the raised access member also having connectors to enable the raised access member to be attached to a power supply.

21. A raised access member according to claim 20, wherein the raised access member is a floor tile with the outer face being able to transmit heat from the floor tile to a space above the tile.

22. A raised access member according to claim 20 in the form of a wall panel, a floor panel or guttering or outside drainage pipes.

23. The raised access member of claim 22, wherein the raised access member is connected to a thermostat or used with a room thermostat for regulating the supply of electricity to the element in response to a measured temperature.

24. A raised access flooring system including one or more raised access members according to claim 23 each of said raised access members also having connectors to enable the raised access member to be attached to a power supply, said system also having one or more pedestals to support respective one or more of said raised access members said pedestals each carrying connectors that can mate with the connectors on respective raised access members so that power can be supplied to the raised access member from power supplies running in a void provided by the one or more raised access members.

25. A heating element according to claims 1 further comprising a thermostat.

26. A heating system including a heating element according to claim 1 wherein the heating element uses a positive temperature coefficient coating to regulate temperature.

27. A heating system according to claim 26 which uses a resettable fuse to protect against over current.
